(19) United States
(12) Patent Application Publication
(10) Pub. No.: US 2026/0161823 A1
(43) Pub. Date: Jun. 11, 2026

(54) IMAGE PROCESSING METHOD AND APPARATUS TO PROTECT PERSONAL INFORMATION

(71) Applicant: FOUNDATION FOR RESEARCH AND BUSINESS, SEOUL NATIONAL UNIVERSITY OF SCIENCE AND TECHNOLOGY, Seoul (KR)

(72) Inventors: Jongyoul PARK, Seoul (KR); Jong Il PARK, Seoul (KR); Hyewon YOON, Seoul (KR)

(73) Assignee: FOUNDATION FOR RESEARCH AND BUSINESS, SEOUL NATIONAL UNIVERSITY OF SCIENCE AND TECHNOLOGY, Seoul (KR)

(21) Appl. No.: 19/393,810

(22) Filed: Nov. 19, 2025

(30) Foreign Application Priority Data
Dec. 6, 2024 (KR) 10-2024-0180216
Jun. 25, 2025 (KR) 10-2025-0084336

(51) Int. Cl. G06F 21/62; G06V 40/16; H04L 9/32

(52) U.S. Cl. CPC G06F 21/6254; G06V 40/168; H04L 9/3236

(57) ABSTRACT

The present disclosure relates to a technology for protecting visual features within an image, and an image processing method includes acquiring an image by capture or input, determining a request for de-identification of personal information in the image, processing the image according to the determined request for de-identification, and storing or transmitting the processed image.

### CROSS-REFERENCE TO RELATED APPLICATIONS

This application claims the benefit of Korea Patent Application No. 10-2024-0180216, filed on Dec. 6, 2024, and Korea Patent Application No. 10-2025-0084336, filed on Jun. 25, 2025, which is incorporated herein by reference for all purposes as if fully set forth herein.

### TECHNICAL FIELD

The present disclosure relates to a technology for protecting visual features in an image, and more specifically, to an image processing method and apparatus for de-identifying visual features within an image to protect personal information of a personal in an image.

### BACKGROUND

Images containing individuals'faces are being used in various ways in video conferencing and social media. With the growing adoption of telecommuting and remote work, video conferencing has become an essential tool for professional situations, such as workplace communication, interviews, online classes, seminars, etc. On social media, individuals'faces are widely used to express themselves, maintain communication with friends and family, and share content. These technologies enable the formation and maintenance of relationships even in non-face-to-face environments and contribute to enhancing the quality of communication through video and real-time interaction. In addition, these technologies significantly expand the freedom of individual expression by providing anyone with the opportunity to create content and convey messages using their own faces.

However, despite these advantages, there are also some drawbacks. Data containing facial images carries the risk of privacy violations, and facial recognition technology can be used or misused without authorization. In particular, identity theft and the spread of misinformation using deepfake technology are raising serious social concerns. In addition, excessive appearance-based evaluations and comparisons on social media are leading to an increase in mental health issues, such as low self-esteem, anxiety, and depression. These technological advancements are sparking discussions about not only security and ethical issues, but also legal regulations.

With the advancement of artificial intelligence technology, various forms of personal information are newly emerging. Among these, image information representing various characteristics of an individual in addition to facial information is being used as personal information. The visual features are used to distinguish objects from one another. The visual features can be represented by various characteristics of visual objects in visual data. For object recognition within an image, various image features, such as scale invariant feature transform (SIFT), histogram of oriented gradient (HOG), speed-up robust feature (SURF), Haar, ferns, local binary pattern (LBP), and modified census transform (MCT), can be used. These visual features not only represent the unique characteristics of objects but also sometimes exhibit the unique characteristics of specific individuals, and thus are very important in terms of recognition and require protection.

The need for protection of images containing individuals'faces in video conferencing and social media needs to be emphasized from this perspective. In this regard, considering the widespread adoption of facial recognition technology in the age of artificial intelligence, visual features can be extracted from images containing faces for facial recognition, and in this case, problems related to personal information protection can occur. For example, visual features that can identify individuals, that is, personal information, can be leaked from the facial information of conference participants displayed in video conferences or photos shared on social networks.

In recognition of such problems, the patent document presented below disclose technical means for performing video conferences using a realistic avatar based on actual imagery, without exposing the user's real image. However, no clear criteria for defining the scope of personal information to be protected are provided, and no comprehensive technical means for protecting images containing individuals'faces, in addition to the illustrated video conference are presented.

[Patent Document] Korean Laid-Open Patent No. 10-2022-0082382, “Realistic video conference system and method based on reconstructed 3D avatars using real imagery”

### SUMMARY

Embodiments of the present disclosure are directed to overcoming the weakness of direct exposure of personal information when using real facial images or extracted key features in the field of facial image handling, including conventional video conferencing, metaverse, digital twins, social media, and the like, also overcoming the loss of unique characteristics due to a substitute image unrelated to the individual's facial features generated when using avatar or persona images instead of actual facial images or facial images containing key features, and more fundamentally, solving the problem that there is no technical means for initially protecting personal information from images when the images containing personal information are acquired.

In order to solve the above-described technical problems, in one aspect of the present disclosure, there is provided an image processing method comprising acquiring an image by capture or input; determining a request for de-identification of personal information in the image; processing the image according to the determined request for de-identification; and storing or transmitting the processed image.

The acquiring of the image by capture may include detecting an operation of storing data acquired through an image sensor in a buffer memory, detecting an intensity or change in an optical signal received through the image sensor, detecting a change in power consumption of the image sensor, detecting an activation timing or operation of an electronic shutter, or detecting a normal response of the image sensor corresponding to a trigger signal commanding shooting.

The acquiring of the image by input may include determining whether a data format is an image by checking at least one of a header, extension, attribute information, or metadata of the data received through a communication channel or an input unit, recognizing an image type by checking a multipurpose Internet mail extensions (MIME) type of the received data, determining whether the data is an image by analyzing a pattern or statistical characteristics of the received data, determining whether the data is an image by checking compressed information or a data structure of a stream of the received data on a chunk-by-chunk basis or identifying a predetermined frame or marker in the stream, or determining whether the data is an image by generating a hash value from the received data and comparing the hash value with a hash value of a predetermined image type.

The determining of the request for de-identification may include, when the image includes a facial region or a security policy for the image is preset, determining at least one of whether to de-identify personal information contained in the image and the level of de-identification.

When the request for de-identification is present, the processing of the image may include extracting feature information about the facial region from the image; transforming the extracted feature information to provide a guide for a portion to be generated within the facial region; and performing de-identification based on the provided guide.

The extracting of the feature information may include at least one of extracting region-specific features from the input image in different region sizes; and performing masking on the input image in grid units of different sizes. The providing of the guide may include removing or transforming the feature information corresponding to a portion to be newly generated within the facial region according to a preset transformation rule or a transformation level included in the request for de-identification. The extracting of the feature information may include learning parameters related to forward transformation from a facial image to noise using a diffusion model, and the performing of the de-identification may include generating a de-identified facial image from the noise by reverse transformation of the diffusion model based on the guide which removes or modifies feature information.

The storing or transmitting of the image may further include additionally checking whether personal information remains in a target image to be stored or transmitted by monitoring the storage or transmission operation; and re-performing the de-identification process on the personal information through the processing of the image when the personal information remains based on results of the additional check.

The operation of storing or transmitting the image may include delaying the operation of storing the image in a storage unit or the operation of transmitting the image to another device, until the completion of the determination of the request for de-identification and the image processing in response to the request for de-identification.

When the capture of the acquired image or the input of the image is a video, the processing of the image may be performed on all frames constituting the video or at least key frames for each scene constituting the video.

The present invention also provides a computer-readable recording medium in which a program for executing the image processing method has been recorded on a computer.

In order to solve the above-described technical problems, in another aspect of the present disclosure, there is provided an image processing apparatus comprising a memory configured to store a program for performing image processing for personal information protection; and a processor configured to execute the program stored in the memory, and the program includes commands to acquire an image through capture or input, determine a request for de-identification of personal information in the image, extract feature information about a facial region from the image based on the determined request for de-identification, transform the extracted feature information to provide a guide for a portion to be generated within the facial region, perform de-identification based on the provided guide, and store or transmit the de-identified image.

The program may be configured to learn parameters related to forward transformation from a facial image to noise using a diffusion model and extract the feature information, and generate a de-identified facial image from the noise by reverse transformation of the diffusion model based on a guide which removes or modifies the feature information.

The program may be configured to additionally check whether personal information remains in a target image to be stored or transmitted by monitoring the storage or transmission operation, and re-perform the de-identification process on the personal information through the processing of the image when the personal information remains based on results of the additional check.

The program may be configured to delay the operation of storing the image in a storage unit or the operation of transmitting the image to another device, until the completion of the determination of the request for de-identification and the image processing in response to the request for de-identification.

According to embodiments of the present disclosure, it is possible to protect personal information from malicious access while enabling visual recognition by others, by providing a de-identified substitute image that uses unique visual features of an image containing personal information but masks information that serves as a key factor in identifying the individual, and to ensure safety by detecting, at an early stage, the moment when an image containing personal information is acquired and taking preemptive personal information protection measures before the image is recorded or transmitted to another device or service.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 is a view illustrating an image processing process for protecting personal information when transmitting an image containing personal information over a network or posting the image online.

FIG. 2 is a flowchart illustrating an image processing method for protecting personal information according to one embodiment of the present disclosure.

FIG. 3 is a view illustrating an overview of a de-identification process according to the embodiments of the present disclosure.

FIG. 4 is a view for describing a process of extracting features in units of region when extracting feature information about a facial region.

FIG. 5 is a view for describing a process of performing grid-based masking when extracting feature information about a facial region.

FIG. 6 is a view for describing a process of generating a de-identified image using a diffusion model.

FIG. 7 is a view for describing an image processing process when continuous images, such as a video, are input.

FIG. 8 is a view illustrating the results of image processing for protecting personal information in a video conference.

FIG. 9 is a block diagram illustrating an image processing apparatus for protecting personal information according to one embodiment of the present disclosure.

### DETAILED DESCRIPTION

Reference will now be made in detail to embodiments of the disclosure, examples of which are illustrated in the accompanying drawings. Detailed descriptions of known arts will be omitted if such may mislead the gist of embodiments of the present disclosure. In addition, throughout the present disclosure, “comprising” a certain component means that other components may be further comprised, not that other components are excluded, unless otherwise stated.

Terms used in the present disclosure are only used to describe specific embodiments, and are not intended to limit the present disclosure. Expressions in the singular form include the meaning of the plural form unless they clearly mean otherwise in the context. In the present disclosure, expressions such as “comprise” or “have” are intended to mean that the described features, numbers, steps, operations, components, parts, or combinations thereof exist, and should not be understood to be intended to exclude in advance the presence or possibility of addition of one or more other features, numbers, steps, operations, components, parts, or combinations thereof.

Unless otherwise specified, all of the terms which are used herein, including the technical or scientific terms, have the same meanings as those that are generally understood by a person having ordinary skill in the art to which the present disclosure pertains. The terms defined in a generally used dictionary can be understood to have meanings identical to those used in the context of a related art, and are not to be construed to have ideal or excessively formal meanings unless they are obviously specified in the present disclosure.

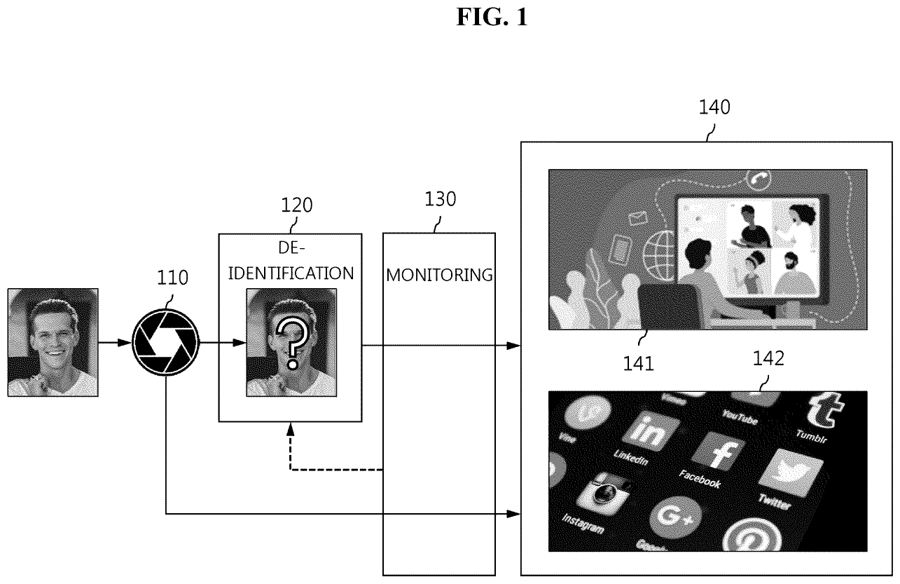

FIG. 1 is a view illustrating an image processing process for protecting personal information when transmitting an image containing personal information over a network or posting the image online. FIG. 1 assumes that an individual's facial image is used for application services, such as video conferencing 141, social media 142, metaverse, etc. A user captures an image containing his/her face using a camera/cam 110 provided on a smartphone or computer. In this case, for example, typical video conferencing services currently in service are implemented by transmitting the captured facial image or applying a slight image filter.

In contrast, the embodiments of the present disclosure presented in FIG. 1 perform de-identification processing, which takes technical measures to protect personal information from the image acquired by an image processing apparatus 120, and then provides the de-identified image to a service server 140 for video conferencing 141 or social media 142. Here, a target of de-identification may be a “face” in which personal information or visual features capable of identifying an individual are concentrated.

The de-identification process may include setting a region of interest (ROI) and converting the ROI into another image or data. First, prior to image processing, the system may perform preprocessing, such as resizing an original image or reducing noise. For images containing faces, the system may detect a person before detecting the background or other objects. Then, the system extracts an image region of a target object based on the de-identified object. In particular, objects may be aligned around an ROI or a specific object may be extracted. Now, visual features of the specified object and the extracted region are de-identified. De-identification of visual features may be implemented using various methods or algorithms, and the impact and extent to which each method interferes with an individual's unique features may differ.

As previously noted, visual features contained within facial images correspond to highly sensitive personal information and thus require adequate protection. The problem lies in the difficulty of determining which personal information among various data contained in facial images needs to be technically protected, and what level of protection is required. The greater the degree to which visual features are modified or removed, the more a substitute image corresponding to a facial image loses the individual's unique characteristics, and conversely, preserving the visual features reduces the effectiveness of personal information protection.

The embodiments of the present disclosure propose de-identification performed by removing or modifying an individual's facial features. As a result, “me who is not me” may be created. This method removes identifying features from the face, and although other features remaining in the image still give the appearance of a human face, the de-identified face makes it difficult to clearly identify the individual. In some cases, this method may create the impression of a similar person to the original image and subtly make the person appear different. Furthermore, acquaintances of the person may perceive the image as similar, but facial recognition algorithms may determine that the two individuals are different. This is because the unique facial features have been removed or modified, causing the facial recognition algorithm to identify the corresponding person as a different individual. In the embodiments of the present disclosure, the privacy to be protected refers to an individual's facial features, but these features refer to a means of distinguishing an individual's identity from the perspective of a device, machine, or algorithm that attempts to identify the individual from others. Accordingly, for example, video conference participants may recognize individuals, but the facial image in this case can be prevented from being used for illegal purposes, such as authenticating or identifying others.

Meanwhile, the embodiments of the present disclosure presented in FIG. 1 can enforce de-identification processing for acquired images before transmitted to or stored in another device 140. Such a configuration was conceived from the recognition that there is no technical means to initially protect personal information from images when the images containing personal information were acquired, and to this end, a component for detecting the time when the images were acquired or determining whether personal information, such as a facial image, is included in such images is required.

Furthermore, referring to FIG. 1, a monitoring unit 130 may monitor the operation of storing or transmitting the image to another device 140, such as a server for services, to further check whether unprocessed personal information remains within a target image. The image processing apparatus 120 is, in principle, required to de-identify images containing personal information, but there may still remain personal information that has not been de-identified. Alternatively, images acquired through the camera/cam 110 directly without de-identification processing of the image processing apparatus 120 may be transmitted to another device 140. To prevent this, the monitoring unit 130 may monitor the storage or transmission operation to another device 140 to prevent unauthorized exposure of personal information. When personal information is detected during an additional inspection process, the personal information may be re-transferred to the image processing apparatus 120 to perform de-identification once more. The image processing apparatus 120 and the monitoring unit 130 are illustrated as functionally separate, but may be software modules physically implemented within a single device. For example, de-identification and additional monitoring functions may be implemented within a single mobile phone or computer.

The embodiments of the present disclosure presented below proactively detect a timing when a system/device acquires or receives an image, and when a facial image is present within the image, de-identify the facial image to protect personal information. During de-identification, rather than generating an image that is dissimilar to the individual's original facial image, a similar image is generated, and personal information protection and anonymization can be achieved according to the required level of de-identification for the captured facial image.

Unlike conventional mathematical models or redundant data, the generation-based de-identification technique uses data from a cognitive perspective, and thus unlike conventional techniques, the generation-based de-identification technique does not require user resistance and may be restored or transformed using a small amount of data as needed. Various embodiments of the present disclosure propose a guide-based generation technique that preserves shape and characteristics. The guide-based generation technique recognizes the feature points of facial information and use the feature points as guides to generate the facial information. That is, this technique preserves specific parts that reflect features from each region, rather than feature points, during the process of generating de-identified virtual facial data and uses the guides to generate other parts. To this end, a guide for a part to be masked is provided, and a de-identified facial image is generated based on the guide. In particular, this technique is to generate facial features that prevent the loss of data to be protected by adding additional data to the facial features. The addition of the additional data can be achieved through the following synthesis methods.
1) Facial feature and segmentation synthesis: This method recognizes facial features, segments features, and generates facial features. This method modifies key facial features and preserves the existing data as much as possible, making it applicable even when only the desired portion is modified in situations with low completeness or heterogeneity. In addition, the segmentation itself provides security.
2) Facial feature and regional part synthesis: Previous segmentation methods crop and process feature parts, while this method pre-segments multiple parts of the face and transforms classified data. This method reveals features that modify parts that people perceive as cognitively important. Accordingly, this method addresses general aspects rather than the importance of data.
3) Facial feature, regional part of face, and grid-based masking synthesis: In addition to using features for each region, this method masks each part using a grid. Through masking, local data is preserved and then expanded, enabling de-identification.

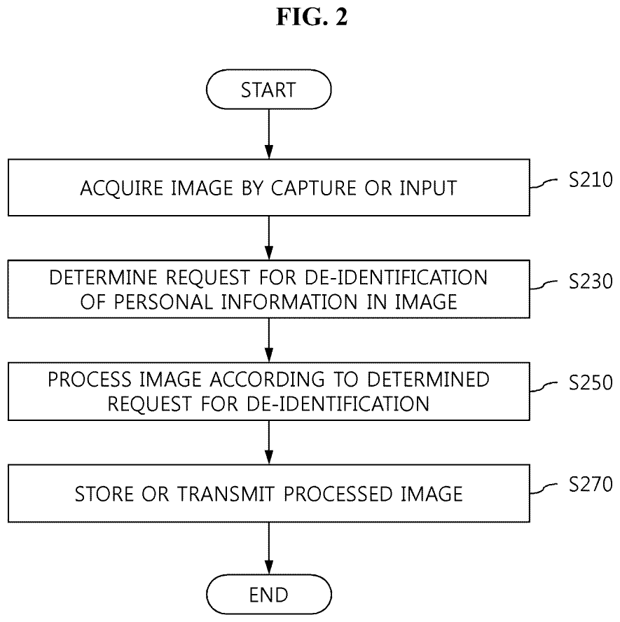

FIG. 2 is a flowchart illustrating an image processing method for personal information protection according to one embodiment of the present disclosure, and the method may be implemented by an image processing apparatus having at least one processor executing a program including commands for performing a series of processing operations.

In operation S210, the image processing apparatus acquires an image by capturing or inputting the image. This operation may further include detecting image capture or image input. The image processing apparatus needs to proactively detect a timing when the image is captured or received to take necessary actions before the image is recorded on a storage device or transmitted to another device. To this end, various technical means for time-point detection may be used.

### 1. Means for Detecting Capture of Image

A typical technical means for detecting image capture may detect an operation of storing data acquired through an image sensor in a buffer memory, detect the intensity or change in an optical signal received through the image sensor, detect changes in the power consumption of the image sensor, detect the activation or operation of an electronic shutter, or detect the normal response of the image sensor corresponding to a trigger signal commanding capture. A technical means for detecting the moment or timing of the image capture may be implemented by combining various sensors, signal processing technologies, and software analysis.

### 1-1) Detection of Storage Operation of Buffer Memory

The moment data acquired from the image sensor is temporarily stored in a buffer memory may be detected to record a capture timing. The timing of the image capture may be determined by detecting a signal when the image sensor transmits data to a memory after the completion of data capture, or monitoring a data state (writing, reading, emptying, etc.) of the buffer memory in real time.

### 1-2) Operation of Shutter or Signal Detection of Image Sensor

In digital cameras or smartphones, an electronic signal is generated the moment a shutter button is pressed, and this signal allows the precise moment of capture to be detected. In the case of a physical shutter button, a contact signal generated when the button is pressed may be read to record the capture timing. In contrast, an electronic shutter may record an electronic timestamp at the moment the sensor captures data. In addition, an image sensor may detect light and convert the detected light into an electrical signal, and the moment of capture may be determined based on the timing when this signal is generated. From an implementation perspective, the capture timing may be detected based on the time pixel data begins to be read from a CMOS or CCD sensor, and both global shutter and rolling shutter methods are applicable. The global shutter may record based on the timing when all pixels are exposed simultaneously, the rolling shutter may generate a timestamp by integrating the exposure timing data on a line-by-line basis, and the timing of the image capture may be determined by capturing the trigger signal generated by the electronic shutter circuit in real time.

### 1-3) Detection of Capture Trigger Signal and Image Sensor Response

The timing when the image sensor responds normally to a capture trigger signal generated externally or internally may be detected. When a trigger signal (e.g., a transistor-transistor logic (TTL) or general purpose interface port (GPIO) signal) is generated, a data output response of the sensor may be determined, and the delay time between the trigger signal and the sensor response may be calculated to precisely measure the timing.

### 1-4) Detection of State Changes or Signals of Sensor

An on-chip signal (ready/busy status flag) may detect changes in an operation state (standby→enabled→disabled) of the image sensor to record the capture timing or monitor an operation mode (exposure, read, transmission) of the sensor to determine the capture timing. Alternatively, a timing controller (TCON) for controlling an image sensor and a processor may record the moment a capture signal is generated. The timing controller may manage a data flow between a sensor and a storage device and record a timestamp based on the timing when a capture command is received.

### 1-5) Detection of Optical Changes

The moment of capture may be recognized by detecting changes in the intensity or pattern of light introduced through the lens. The sensor may detect optical signals resulting from aperture changes or shutter operation at specific timings, and based on the pattern of light changes (e.g., flash activation), the capture timing may be recorded. Alternatively, the capture timing may be determined by detecting the moment when a flash occurs. A light sensor may be used to detect a momentary increase in flash light, and an electronic circuit linked to the flash may record the capture signal, thereby detecting the capture timing.

### 1-6) Detection of Power Consumption Changes

The capture timing may be recorded by detecting changes in power consumption that occur when the image sensor is activated. From an implementation perspective, the timing of the image capture may be specified by monitoring changes in current and voltage in a power supply circuit and recording power events associated with the operation state of the sensor.

### 1-7) Detection of Audio and Vibration Signals

The capture timing may be recognized by detecting an acoustic signal (shutter sound) or vibration generated by the camera during capture. The image capture timing may be determined by detecting shutter sound or mechanical movement using a small microphone or vibration sensor.

### 1-8) Time-Based Processing

A system clock may be used to record the moment the capture command is issued as a timestamp. At an operating system level, a system time at the moment a camera app executes the capture command may be recorded, and a timestamp may be included in an image metadata (EXIF) to detect the timing of the image capture.

### 1-9) Multi-Sensor Fusion

Multiple sensors (an image sensor, an accelerometer, a gyroscope, a microphone, etc.) may be fused to detect the capture timing and improve accuracy. In this case, an image capture signal, vibration data, and acoustic data may be integrally analyzed, and an AI-based algorithm may be used to calculate the optimal timing to infer the timing of the image capture.

1-10) Synchronization with External Signals

The capture timing may be precisely recorded by synchronizing the camera system with signals provided by external devices (e.g., a GPS and a remote timer). A timestamp may be recorded based on time data provided by GPS signals, and precise timing may be detected by synchronizing with an external timer or trigger device.

In summary, the detection of the capture moment or timing may be implemented based on the operation of the sensor, the state of the memory, electronic signals, or external signals, and systems that combine hardware signal detection with software timekeeping are effective. An optimal method may be determined according to factors, such as usage environments, accuracy requirements, costs, and the like, and multi-sensor fusion and AI-based analysis may provide greater reliability and precision.

### 2. Means for Detecting Input of Image

As a representative technical means for detecting an input of an image, the means may determine whether a format of data is an image by checking at least one of a header, an extension, attribute information, or metadata of the data received through a communication channel or an input interface, determine whether it is an image by checking a multipurpose Internet mail extensions (MIME) type of the received data to recognize the image type or analyzing a pattern or statistical characteristic of the received data, determine whether it is an image by checking compression information or a data structure on a chunk-by-chunk basis of a stream of the received data or identifying a predetermined frame or marker in the stream, or determine whether it is an image by generating a hash value from the received data and comparing the generated hash value with a predetermined hash value of the image type. The technical means for detecting the input of the image may be implemented primarily using various methods of analyzing the format and characteristics of the input data.

### 2-1) Data Header Check

Header information of the received data may be analyzed to determine a data format. Unique header signatures for each image file format (e.g., JPEG (FF D8 FF), PNG (89 50 4E 47), GIF (47 49 46 38), etc.) may be compared. When data is processed in a stream manner, first few bytes may be extracted and a header may be checked to quickly identify an image format.

### 2-2) Check File Extension and Attribute Information

Whether data is an image may be determined by checking file extension and attribute information of the data. The format may be inferred by checking the file extension (e.g., jpg, png, bmp, etc.) of the data, or whether the data is an image by searching for image-related attributes (resolution, color profile, etc.) in file metadata.

### 2-3) Check MIME Type

Whether the data is image data by checking the MIME type of the received data. From an implementation perspective, MIME types (e.g., image/jpeg, image/png, image/gif, etc.) may be checked during HTTP requests or file transfers, and a file MIME check API provided by an operating system or library may be used.

### 2-4) Pattern and Statistical Characteristics Analysis

Whether data is image data may be determined by analyzing structural patterns or statistical characteristics of the data. Pixel data distribution, color histograms, and compression characteristics may be analyzed, unique patterns that are distinguished from unstructured data (e.g., text, binary, etc.) may be identified, or machine learning models may be used to learn and determine the characteristics of image data.

### 2-5) Data Chunk Analysis

A data stream may be divided into small chunks and analyzed to determine whether the data is an image. During data transmission, compression information or data structures may be analyzed on a chunk-by-chunk basis and images may be identified using the data block structure of specific image formats, thereby enabling efficient analysis through real-time processing of large-volume stream data.

### 2-6) Hash-Based Data Identification

A hash value of the received data may be compared with a predetermined hash list of the image data. The input of the image may be detected by comparing its hash value with hash values stored in a unique image database and using similar images.

### 2-7) Real-Time Streaming Data Analysis

Image format data may be detected in real-time from streaming data. Real-time image data input in a streaming environment may be detected by extracting specific frames from a video stream and analyzing whether the data is image data, or identifying specific markers (image start/end markers) within the data stream.

### 2-8) AI-Based Data Format Classification

Data formats may be automatically classified using a deep learning or machine learning algorithm. A model learning a binary structure of the input data may be used to determine whether the data is an image.

In summary, to detect the timing when an image was input during data input, various technical means may be used, ranging from traditional methods, such as header, extension, and MIME type checks, to advanced techniques, such as pattern analysis, AI-based classification, etc. Suitability of each method varies depending on the data transmission method, format diversity, and real-time processing requirements, and multiple techniques are combined, thereby improving accuracy.

In operation S230, the image processing apparatus determines whether de-identification is required for the image to protect personal information. During this process, whether personal information, such as facial images, is present in the image may be determined, and thus whether de-identification needs to be applied according to the established protection policy may be determined. More specifically, when the image includes a facial region or a security policy for the image is preset, at least one of whether to de-identify the personal information contained in the image and the level of de-identification may be determined. That is, the de-identification request not only determines whether to de-identify personal information, but also configures the level of de-identification as at least two levels, thereby satisfying the user's needs or the security requirements of the management organization.

In addition, when two or more users participate in a service that provides facial images containing personal information, each user may have a different de-identification request (i.e., whether to de-identify or the level of de-identification). For example, multiple users participating in a video conference may have both non-anonymized original facial images and anonymized facial images, and the levels of anonymization at this time may also be different. However, the minimum security requirements for the service are required to be met. When the administrator requires a minimum level of de-identification, the use of original facial images of video conference participants will be prohibited by policy.

In operation S250, the image processing apparatus processes the image according to the determined de-identification request. When no de-identification request is present, the original facial images will be used. Conversely, when a request for de-identification processing is present or a request for a level of de-identification exceeding the minimum level is present, de-identification will be performed accordingly.

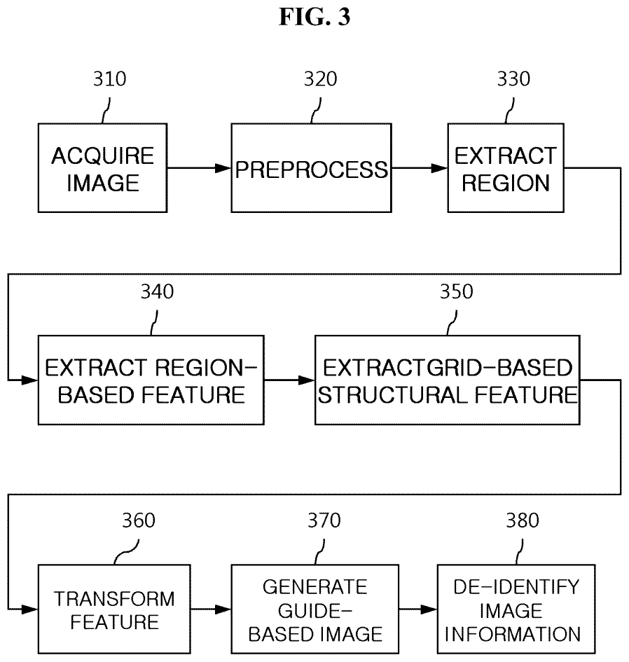

FIG. 3 is a view illustrating an overview of a de-identification process according to the embodiments of the present disclosure. During the de-identification process, decisions may be made as to which regions to target, what information to modify, and how to modify the feature information.

First, an image including a facial region is acquired (310) and preprocessed (320), and then a target region (e.g., a face) is extracted (330). Various embodiments of the present disclosure target significantly preprocessed images (e.g., shadow removal, noise removal, or the like) and assume that deformation or color changes in the acquired image may be corrected through the preprocessing process. Accordingly, it is assumed that images are acquired and preprocessed to achieve an appropriate level of image quality, allowing for the presence of partial occlusions. Then, features may be extracted from the extracted target region using at least one of the two methods.

First, during a region-based feature extraction process 340, features are extracted by varying an input process for size-specific segments from the target image input for learning. To extract features, a method of inputting features extracted from the size-specific segments into individual layers as intermediate information during a process of transforming information from each image region into a latent space.

Second, during a grid-based structural feature extraction process 350, facial information is divided into grids of various sizes, features are extracted, and feature sets for each grid area are overlapped to generate structured feature information.

Next, features to be maintained remain, and features to be removed or modified are transformed according to preset rules or policies (360). Accordingly, a guide-based image is generated (370), thereby achieving image information de-identification (380).

More specifically, when the request for de-identification is present, operation S250 of FIG. 2, which processes an image, may include the following process.

First, feature information about the facial region is extracted from the image. This process may include at least one of extracting region-specific features from the input image in different region sizes, and performing masking on the input image in grid units of different sizes. Feature extraction may be performed by extracting features from the entire face or finding predefined features. However, these methods can have the side effect that information from regions with strong features occludes information from other regions. To prevent this, various embodiments of the present disclosure propose a technique for extracting features from various regions.

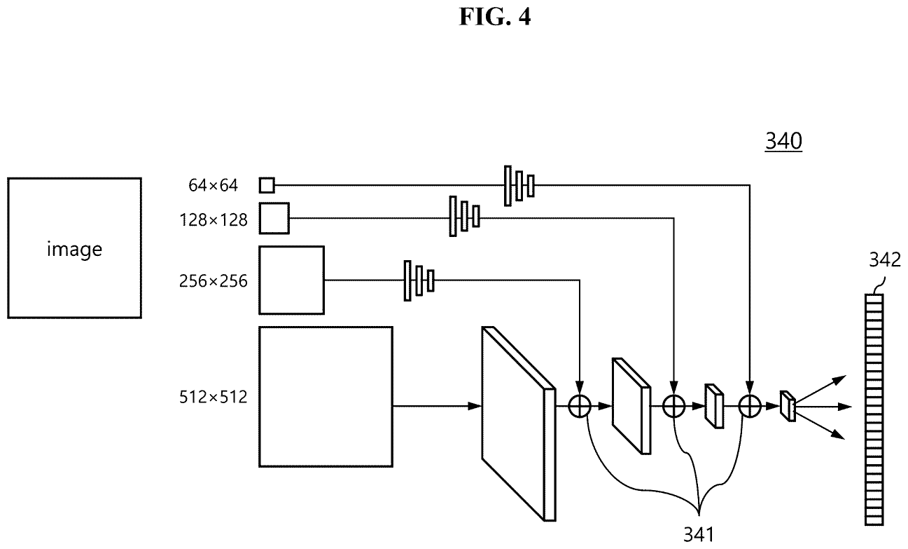

FIG. 4 is a view for describing the process of extracting features in units of region when extracting feature information about a facial region.

When features are extracted from the entire image region, the structure of the learning system is determined regardless of the size of the input image, and thus feature extraction is performed by transforming the image to a predetermined size. Accordingly, when the image may not include features larger than or equal to a specific size, there is a risk of losing important information. Accordingly, one embodiment of the present disclosure proposes a method of extracting features by inputting information about each image region of each size into individual layers during the process of transforming information from the image region into a latent space. Referring to FIG. 4, it can be seen that information about image regions extracted in units of different small sizes is added to individual layers during the process of extracting features of the largest region (341). Since there is a difference between information input during a process of learning feature points and information directly input from individual layers, FIG. 4 illustrates a technique of operating differently depending on the size of the target image input for learning. That is, by extracting features through different input processes for large and small regions, a final latent vector 342 may be obtained. With respect to the produced results, the embodiment of FIG. 4 may further highlight features that operate significantly in small regions. For example, in the case of a small dot on a face, it is difficult to reflect the features of the small dot by extracting features from the entire image region, but in the method of extracting features in units of region, the information representing the small dot is processed separately, allowing for accurate reflection of the visual features of the corresponding information, even at a small size.

Regarding the process of transforming information from an image region into a latent space, FIG. 4 illustrates a method of adding information about image regions extracted from each of relatively smaller image regions (e.g., 256×256, 128×128, 64×64, or the like) with respect to the largest image region (512×512) to individual layers, but this is merely one embodiment and is not limited thereto. For example, it is possible to accumulate information about image regions extracted from each region in a cascade manner. That is, by adding information extracted from a 64×64 image region to a 128×128 image region, adding information extracted from the 128×128 image region to a 256×256 image region, and adding information extracted from the 256×256 image region to a 512×512 image region, information acquired from image regions of different sizes may be hierarchically input into the next stage of the latent space transformation process.

In summary, the process of extracting features from each region may segment the entire image region into exclusive regions of different sizes, and for each segmented exclusive region, the features of the image may be extracted by transforming a high-dimensional image into a low-dimensional image, and then mapped into a latent space, and the image information obtained from relatively smaller regions may be provided as inputs to individual layers during the transformation process of image data corresponding to relatively larger regions, with the input adjusted to match the size of the larger regions.

The above technique for extracting features from each region highlights small features, while the technique to be introduced next segments facial information into grids of different sizes, processes the segmented facial information, and then reassembles the processed facial information to generate structured feature information.

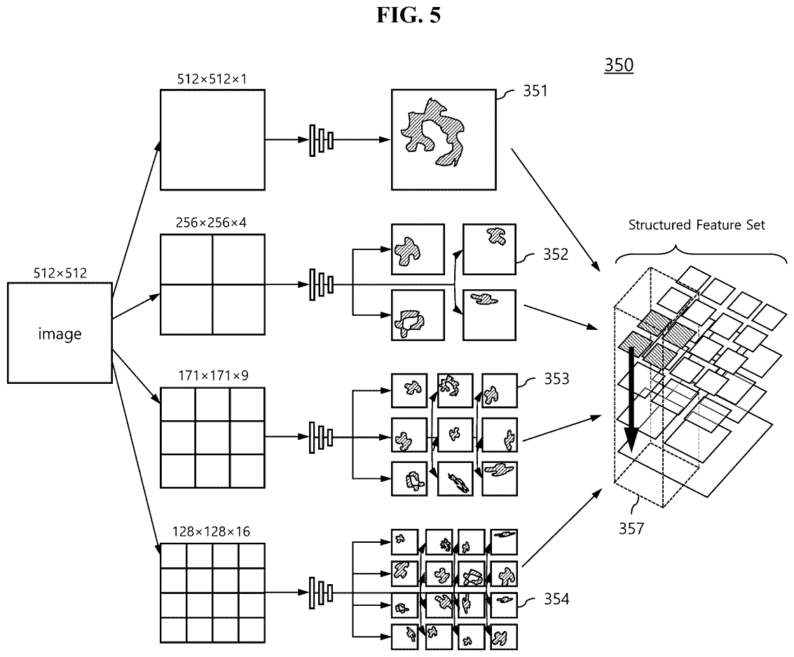

FIG. 5 is a view for describing a process of performing grid-based masking when extracting feature information about a facial region.

Referring to FIG. 5, for example, a method of segmenting the entire image of 512×512 size into grids consisting of 1 image, 4 images of ¼ size (256×256), 9 images of 1/9 size (171×171), 16 images of 1/16 size (128×128), and 25 images of 1/25 size (82×82), processing each grid region, and then restructuring the processed regions is applied. Referring to FIG. 5, feature information 351, 352, 353, and 354 derived from grids of different sizes is illustrated, showing that these are aggregated into a structured feature set.

The grid structure is not configured to repeatedly segment the original region into gradually smaller sizes, such as 1→¼→ 1/16, but rather to be segmented by various ratios, such as 1, ¼, 1/9, and 1/16, so that some overlapping regions are included. That is, grid regions segmented into different sizes may derive features from different perspectives with respect to adjacent regions. In the present embodiment, information about skin tone in the parts and the segmented regions may be included to extract small feature points. Regarding the overlapping grid regions, instead of the four 256×256 images illustrated in FIG. 5, four 300×300 images may be configured. In this case, considering the original image size of 512×512, the four segmented grids may be implemented to overlap each other.

The feature information 351, 352, 353, and 354 derived from grids of different sizes are stacked to correspond to the entire image region, forming a structured feature set. In this case, the entire structured feature set includes features extracted from various perspectives (grid segmentation method) of the entire image region. Accordingly, depending on the transformation rule or purpose, the structured feature set may be used in its entirety or in part. A partial feature set 357 illustrated in FIG. 5 includes feature information derived from grids of different sizes accumulated in the corresponding image region and includes, for example, feature information about four 128×128 images. To focus on features of some specific regions rather than the entire image region, only a portion of the structured feature set corresponding to the corresponding region may be used. For example, to focus on individual features related to lips in an image including the entire body or facial region of a person, only a portion of the structured feature set corresponding to the lips region may be extracted and used for object recognition, transformation, anonymization, etc.

Since the feature point-centered extraction technique for the entire region fail to reflect the overall characteristics of the region, in the present embodiment, the entire region may be segmented into grids of various preset sizes, and feature information may be structured based on these grids, thereby reflecting information about skin features such as spots, freckles, skin tone, skin age, etc. Accordingly, feature information is obtained from relatively large image regions, and features of skin regions are extracted from smaller grid segments and processed into information.

In summary, the masking process may set at least two or more segmentation criteria, segment the entire image region into grids of predetermined sizes according to the set segmentation criteria to extract structural features of the corresponding image for each grid, and grids segmented by different segmentation criteria may overlap in some regions, and aggregate the features extracted from each grid for each region to structure features corresponding to the entire image region. In particular, during the masking process, the skin features may be extracted from relatively smaller grids among the segmented grids.

When the feature information about the facial region is extracted from the image using the two methods, the extracted feature information may be transformed to provide guidance for the desired portion within the facial region. In this case, feature information corresponding to the portion to be newly generated within the facial region may be removed or modified according to the preset transformation rule or the transformation level contained in the request for de-identification.

Previously, region-level feature extraction and grid-based feature extraction and structuring have been proposed to acquire individual characteristics, and these may be used to remove or modify information. The removal or modification of information may be determined according to the user's policies or rules, and the process of generating an image based on the modified information corresponds to the next operation, that is, a guide-based image generation process. The type of manipulation to be applied to an object set as an indicator of an individual features may be set using these transformation rules. For example, modification may be instructed to a heatmap with a specific intensity or higher. The heatmap is a tool that visually represents the degree to which data is concentrated in a specific section and may be used to visualize the features of image data. Accordingly, the de-identification method of the present disclosure may use the heatmap to identify which features within a facial image have been focused on, and compare the intensity within the heatmap to a threshold value to reduce an intensity value in regions with an intensity that is greater than or equal to the threshold value, thereby attenuating the individual features. In addition, when the individual characteristics have been previously generated as the structured feature set, the desired feature transformation can be achieved by manipulating the corresponding feature set in its entirety or in part.

From the perspective of implementation, features may be removed or modified by applying a transformation method using feature sets of general people. In many cases, features are transformed based on similar body types or similar races, and such modified information removes individual features, resulting in a person commonly seen in the surrounding environment. In particular, the embodiments of the present disclosure are intended to achieve de-identification to protect unique personal information that can be used for individual identification, while still including some personal features at a level perceptible to humans. Accordingly, it is preferable to establish a transformation policy or rule that selectively removes only the feature information required by the AI model or identification algorithm.

Now, de-identification may be performed based on the previously provided guide. This process may use generative AI and generate a de-identified facial image based on the guide provided corresponding to the portion to be newly generated.

In addition, the structured feature information extracted from the grid region is used to generate the image. Through this process, features derived from various methods may be used together. In addition, when shape transformation within an image is required, features extracted from a large image region may be modified, and when changes, such as skin tone, are required, feature transformation may be achieved using the information extracted based on grids.

From the perspective of implementation, various generative AI algorithms and models may be used, and hereinafter, an application technique based on a diffusion model will be provided.

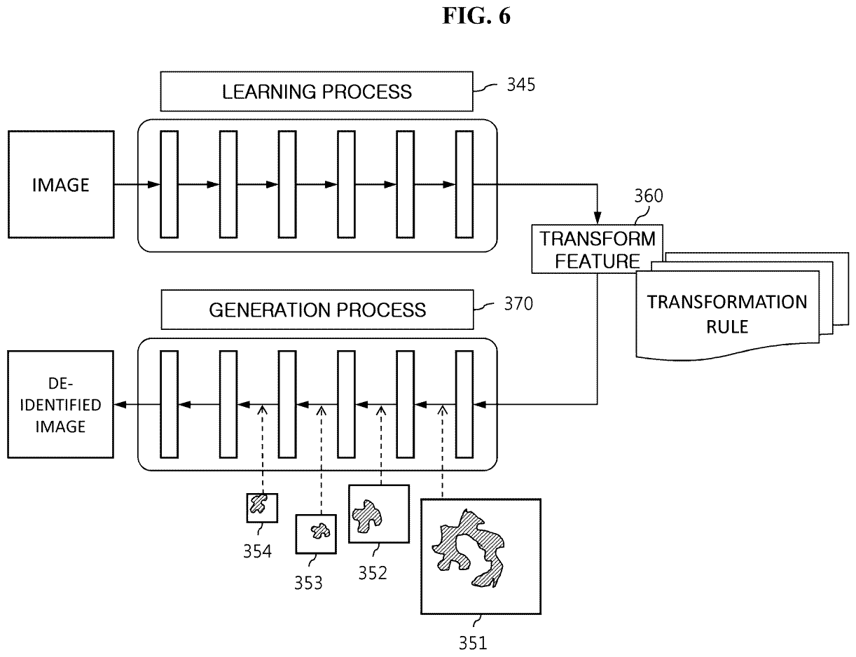

FIG. 6 illustrates a process of generating a de-identified image using a diffusion model. The diffusion model is a generative AI technique that uses a forward procedure (or a diffusion procedure) that transforms data into complete noise while gradually adding noise to the data, and conversely, a reverse procedure that generates data through a denoising process of gradually restoring data from noise, and the detailed description of the diffusion model will be omitted.

Referring to FIG. 6, during the process of extracting feature information, parameters for forward transformation from a facial image to noise are learned through the diffusion model (345). This learning process may be implemented, for example, through the process of extracting features from each region in FIG. 4 or the grid-based masking process in FIG. 5.

Then, during the de-identification process, based on the guide that removes or modifies feature information (360), a de-identified facial image is generated from noise by reverse transformation of the diffusion model (370). In this case, during the reverse transformation of the diffusion model, features extracted from images in relatively larger grid regions may be first used, and features extracted from images in gradually smaller grid regions may be used to generate the facial image. Referring to FIG. 6, it can be seen that the feature information 351, 352, 353, and 354 extracted for each grid size in FIG. 5 are provided to the operations of the reverse transformation, respectively, in descending order of size. Through this generation process 370, a de-identified image meeting the requirements of feature transformation 360 is ultimately generated.

As illustrated in FIG. 6, the diffusion model proposed in the present embodiment may learn an image (345) by obtaining features extracted from each region in the forward transformation or features extracted through the grid-based masking, and by inputting these acquired features while gradually reducing the target region during the reverse transformation process, a de-identified image meeting the requirements of feature transformation (360) may be generated (370) without losing the remaining features of the facial region. In particular, the features extracted through the learning process 345 are used step by step for each region size during the image generation process 370.

The diffusion model proposed in the present embodiment may be implemented using stable diffusion or its derivative models. Accordingly, the diffusion model of FIG. 6 may include components, such as a U-Net, an autoencoder, a transformer, and attention, within the latent space and process noise-to-image modification and inverse transformation mapping through the diffusion function and the U-Net.

Referring back to FIG. 2, in operation S270, the image processing apparatus stores or transmits the processed image. This process describes a process of storing or transmitting an image for which privacy protection measures have been taken through the above process (operation S250) according to its original service purpose. That is, since the necessary protection has been achieved, the image may be recorded on the user's device or transmitted to a video conferencing service or social media server.

In addition, as described above in FIG. 1, additional check may be performed to determine whether unprocessed personal information remains within a target image to be stored or transmitted. The image containing personal information has been processed according to the request for de-identification through operation S250, but personal information that has not been de-identified may still remain in the target image to be stored or transmitted to another device. For example, some personal information may be missing from the de-identification target, or an image acquired through the camera/cam may be transmitted directly to another device without de-identification processing due to the intervention of another application. To address this issue, one embodiment of the present disclosure may further include a separate monitoring process. The monitoring process may monitor operations of storing and transmitting the image in and to another device, thereby preventing unauthorized exposure of personal information. When personal information is detected during the additional check process, the personal information may be transferred back to the image processing process to induce re-application of de-identification. In summary, the storage or transmission process may be monitored to further check whether personal information remains within the target image to be stored or transmitted, and when the personal information remains based on the results of the additional check, the de-identification process may be performed on the corresponding personal information through operation S250, which processes the image.

Furthermore, for proactive protection, the storage or transmission of the image does not need to be performed until the completion of the series of procedures related to de-identification. Accordingly, the operation of storing the image in a storage unit or transmitting the image to another device may be delayed until the completion of the determination of the request for de-identification and the image processing in response to the request for de-identification.

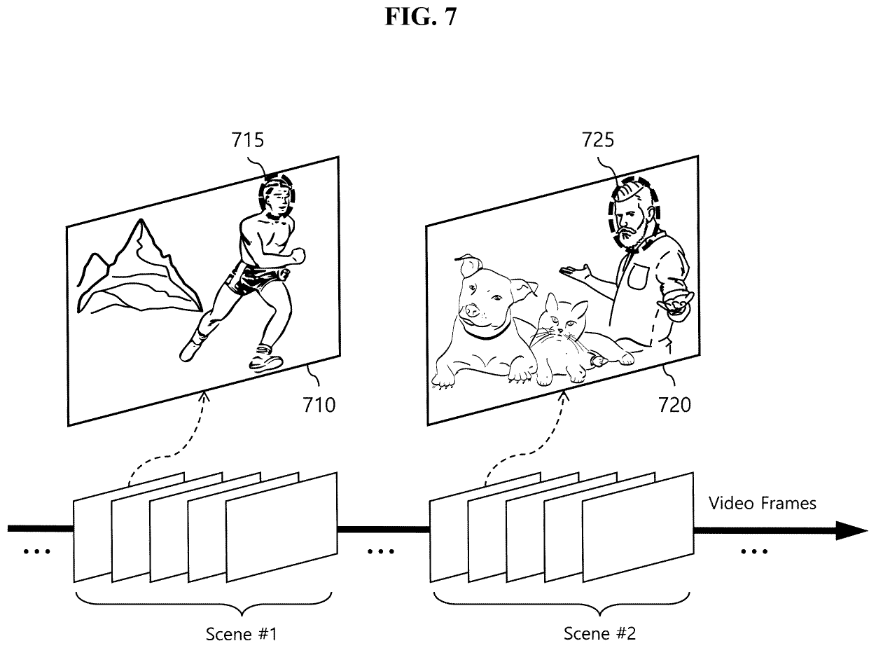

FIG. 7 is a view for describing an image processing process when continuous images, such as a video, are input. When the data input to the system is a single image, such as a photograph, de-identification may be performed on the image. Conversely, when the input data is a video composed of a plurality of frames, consideration needs to be given to the necessary processing.

When the captured image or input image is a video, de-identification may be performed on all frames constituting the video. However, in many recently used video codecs and formats, not all frames in a video have equal importance. In consideration of data transmission efficiency, a video may include key frames.

In video codecs, a key frame (or intra-coded frame, I-frame) is a frame that may be independently decoded and provides a complete image without any information from previous frames. Alternatively, a predicted frame (P-frame) or a bidirectionally interpolated frame (B-frame) rely on key frames or other frames, thereby increasing compression efficiency. The key frames are fundamental reference points in video data and are required to accurately reconstruct the video at specific points during the decoding process, and typically, key frames may be inserted periodically according to an insertion interval (a group of pictures (GOP)) to balance video compression efficiency and decoding performance. Meanwhile, a scene change in a video refers to a moment when the visual content of the video significantly changes, such as when a new object, background, or lighting changes abruptly. Accordingly, key frames are primarily used in connection with scene changes.

Referring to FIG. 7, it is assumed that a series of video frames composed over time include a plurality of scenes, each of which contains key frames 710 and 720. The image processing methods proposed in the embodiments of the present disclosure may be used to check whether a facial image is included in the key frames 710 and 720 for privacy protection, and based on the determined request for de-identification accordingly, de-identification processing may be performed on facial regions 715 and 725. That is, de-identification is preferably performed on at least key frames for each scene constituting the video.

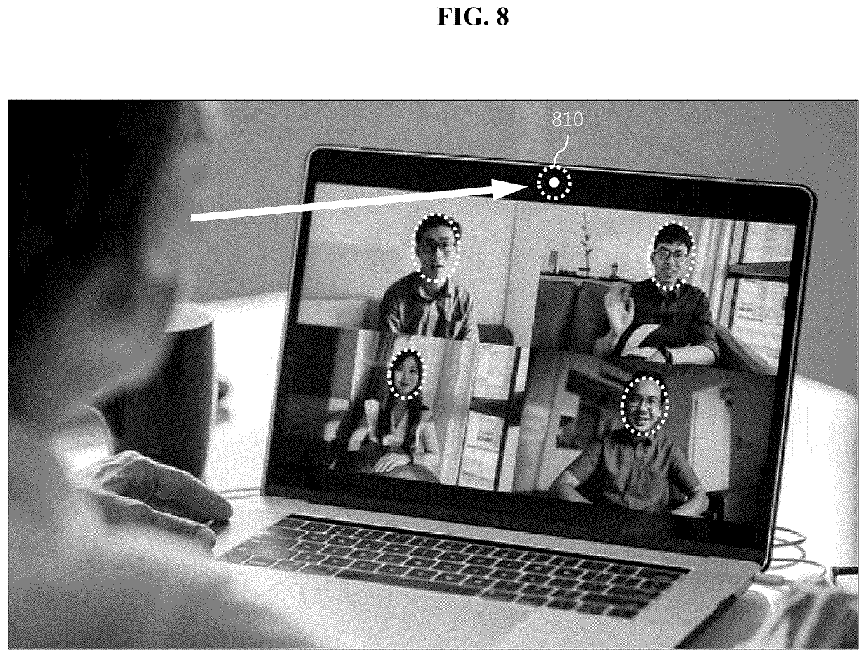

FIG. 8 is a view illustrating the results of image processing for protecting personal information in a video conference. Referring to FIG. 8, a user is participating in a video conference using a webcam 810 installed on his or her laptop PC. At this time, adequate de-identification processing may be performed on the user's facial image captured through the webcam 810, and the de-identified facial image may be displayed to conference participants.

As illustrated in FIG. 8, the de-identification technology proposed in the embodiments of the present disclosure is crucial when considering video conferencing, digital twins, or metaverse environments that do not use actual photographs of an individual's face. In particular, when amplifying visual features of a user's face or appearance, such as a virtual avatar, the need for privacy protection becomes even greater. The embodiments of the present disclosure adopt a de-identification policy that selectively modifies or deletes some personally identifiable features to achieve privacy protection while relying on visual features within a facial image. Accordingly, when other meeting participants have previously met the user, the participants will be able to recognize the de-identified image displayed through the video conferencing as a natural human face and also recognize the corresponding user. However, even when the de-identified facial image is captured, attempts to use the image for illicit purposes, such as facial recognition or identification, will be prevented because the important identifying features used for personal identification have been deleted or replaced. Likewise, other meeting participants will each be subjected to de-identification of their facial regions to meet their own set level of privacy protection or the minimum level set by the administrator. Accordingly, the de-identified image is displayed on the video conferencing screen according to the privacy policy.

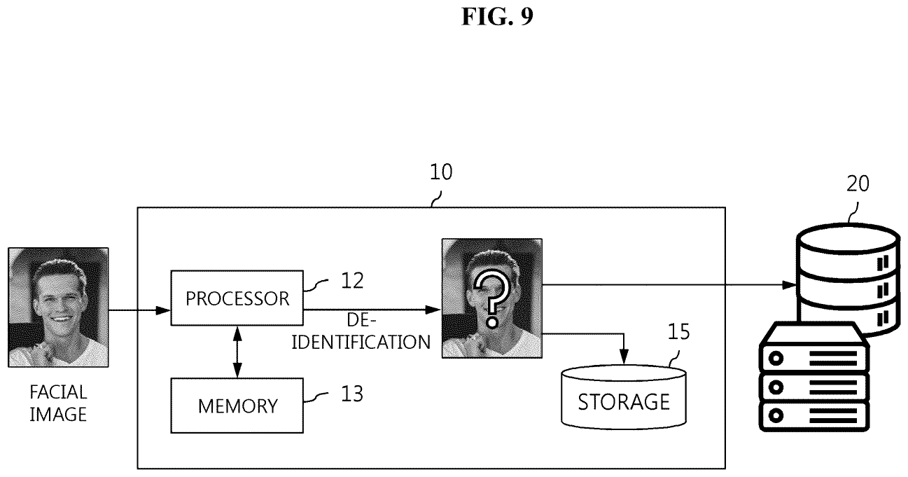

FIG. 9 is a block diagram illustrating an image processing apparatus for personal information protection according to one embodiment of the present disclosure and illustrates the reconstruction of the image processing process of FIG. 3. Accordingly, to avoid overlapping descriptions, the components of each device are briefly described herein, focusing on their functions.

An image processing apparatus 10 includes a memory 13 for storing a program for performing image processing for personal information protection, and a processor 12 for executing the program stored in the memory 13. Here, the program includes commands to acquire an image through capture or input, determine a request for de-identification of personal information in the image, extract feature information about a facial region from the image based on the determined request for de-identification, transform the extracted feature information to provide a guide for a portion to be generated within the facial region, perform de-identification based on the provided guide, and store or transmit the de-identified image.

In addition, the image processing apparatus 10 may further include a storage unit 15 for storing the de-identified image, or transmit the de-identified image to another device (e.g., a video conferencing server, a social media server, or another user device) 20.

Prior to de-identifying the image, the program may detect the capture of the image or the input of the image during the process of acquiring the image. The program may detect the capture of the image by detecting an operation of storing data acquired through an image sensor in a buffer memory, detecting the intensity or change in an optical signal received through the image sensor, detecting changes in the power consumption of the image sensor, detecting the activation or operation of an electronic shutter, or detecting the normal response of the image sensor corresponding to a trigger signal commanding capture. In addition, the program may detect the input of the image by determining whether a format of data is an image by checking at least one of a header, an extension, attribute information, or metadata of the data received through a communication channel or an input interface, determining whether it is an image by checking a multipurpose Internet mail extensions (MIME) type of the received data to recognize the image type or analyzing a pattern or statistical characteristic of the received data, determining whether it is an image by checking compression information or a data structure on a chunk-by-chunk basis of a stream of the received data or identifying a predetermined frame or marker in the stream, or determining whether it is an image by generating a hash value from the received data and comparing the generated hash value with a predetermined hash value of the image type.

The program may learn parameters related to forward transformation of a facial image into noise through a diffusion model to extract the feature information, and generate a de-identified facial image from the noise by performing a reverse transformation of the diffusion model based on a guide that removes or modifies the feature information.

In addition, the program may monitor the storage or transmission process to further check whether personal information remains within the target image to be stored or transmitted, and when the personal information remains based on the results of the additional check, the program may re-perform the de-identification process on the corresponding personal information.

Furthermore, the program may delay the operation of storing the image in a storage unit or transmitting the image to another device until the completion of the determination of the request for de-identification and the image processing in response to the request for de-identification.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like. When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

Embodiments of the present disclosure can be implemented as computer-readable codes on a computer-readable recording medium. The computer-readable recording medium includes all types of recording devices in which data readable by a computer system is stored. Examples of the computer-readable recording medium include a ROM, a RAM, a CD-ROM, a magnetic tape, a floppy disk, an optical data storage device, etc. Further, the computer-readable recording medium may be distributed to computer systems connected over a network, and computer-readable codes may be stored and executed in a distributed manner. Functional programs, codes, and code segments for implementing embodiments of the present disclosure can be easily construed by programmers skilled in the art to which the present disclosure pertains.

According to the embodiments of the present disclosure, it is possible to protect personal information from malicious access while enabling visual recognition by others, by providing a de-identified substitute image that uses unique visual features of an image containing personal information but masks information that serves as a key factor in identifying the individual, and to ensure safety by detecting, at an early stage, the moment when an image containing personal information is acquired and taking preemptive personal information protection measures before the image is recorded or transmitted to another device or service.

As described above, the present disclosure has been examined focusing on its various embodiments. A person with ordinary skills in the technical field to which the present disclosure pertains will be able to understand that the various embodiments can be implemented in modified forms within the scope of the essential characteristics of the present disclosure. Therefore, the disclosed embodiments are to be considered illustrative rather than restrictive. The scope of the present disclosure is shown in the claims rather than the foregoing description, and all differences within the scope should be construed as being included in the present disclosure.

What is claimed is:

1. An image processing method comprising:
acquiring an image by capture or input;
determining a request for de-identification of personal information in the image;
processing the image according to the determined request for de-identification; and
storing or transmitting the processed image.

2. The image processing method of claim 1, wherein the acquiring of the image by capture includes:
detecting an operation of storing data acquired through an image sensor in a buffer memory;
detecting an intensity or change in an optical signal received through the image sensor;
detecting a change in power consumption of the image sensor;
detecting an activation timing or operation of an electronic shutter; or
detecting a normal response of the image sensor corresponding to a trigger signal commanding shooting.

3. The image processing method of claim 1, wherein the acquiring of the image by input includes:
determining whether a data format is an image by checking at least one of a header, extension, attribute information, or metadata of the data received through a communication channel or an input unit;
recognizing an image type by checking a multipurpose Internet mail extensions (MIME) type of the received data;
determining whether the data is an image by analyzing a pattern or statistical characteristics of the received data;
determining whether the data is an image by checking compressed information or a data structure of a stream of the received data on a chunk-by-chunk basis or identifying a predetermined frame or marker in the stream; or
determining whether the data is an image by generating a hash value from the received data and comparing the hash value with a hash value of a predetermined image type.

4. The image processing method of claim 1, wherein the determining of the request for de-identification includes, when the image includes a facial region or a security policy for the image is preset, determining at least one of whether to de-identify personal information contained in the image and the level of de-identification.

5. The image processing method of claim 1, wherein, when the request for de-identification is present, the processing of the image includes:
extracting feature information about the facial region from the image;
transforming the extracted feature information to provide a guide for a portion to be generated within the facial region; and
performing de-identification based on the provided guide.

6. The image processing method of claim 5, wherein the extracting of the feature information includes at least one of:
extracting region-specific features from the input image in different region sizes; and
performing masking on the input image in grid units of different sizes.

7. The image processing method of claim 5, wherein the providing of the guide includes removing or transforming the feature information corresponding to a portion to be newly generated within the facial region according to a preset transformation rule or a transformation level included in the request for de-identification.

8. The image processing method of claim 5, wherein the extracting of the feature information includes learning parameters related to forward transformation from a facial image to noise using a diffusion model, and
the performing of the de-identification includes generating a de-identified facial image from the noise by reverse transformation of the diffusion model based on the guide which removes or modifies feature information.

9. The image processing method of claim 1, wherein the storing or transmitting of the image further includes:
additionally checking whether personal information remains in a target image to be stored or transmitted by monitoring the storage or transmission operation; and
re-performing the de-identification process on the personal information through the processing of the image when the personal information remains based on results of the additional check.

10. The image processing method of claim 1, wherein the operation of storing or transmitting the image includes delaying the operation of storing the image in a storage unit or the operation of transmitting the image to another device, until the completion of the determination of the request for de-identification and the image processing in response to the request for de-identification.

11. The image processing method of claim 1, wherein, when the capture of the acquired image or the input of the image is a video, the processing of the image is performed on all frames constituting the video or at least key frames for each scene constituting the video.

12. An image processing apparatus comprising:
a memory configured to store a program for performing image processing for personal information protection; and
a processor configured to execute the program stored in the memory,
wherein the program includes commands to acquire an image through capture or input, determine a request for de-identification of personal information in the image, extract feature information about a facial region from the image based on the determined request for de-identification, transform the extracted feature information to provide a guide for a portion to be generated within the facial region, perform de-identification based on the provided guide, and store or transmit the de-identified image.

13. The image processing apparatus of claim 12, wherein the program is configured to:
learn parameters related to forward transformation from a facial image to noise using a diffusion model and extract the feature information; and
generate a de-identified facial image from the noise by reverse transformation of the diffusion model based on a guide which removes or modifies the feature information.

14. The image processing apparatus of claim 12, wherein the program is configured to:
additionally check whether personal information remains in a target image to be stored or transmitted by monitoring the storage or transmission operation; and
re-perform the de-identification process on the personal information through the processing of the image when the personal information remains based on results of the additional check.

15. The image processing apparatus of claim 12, wherein the program is configured to delay the operation of storing the image in a storage unit or the operation of transmitting the image to another device, until the completion of the determination of the request for de-identification and the image processing in response to the request for de-identification.
